(19) United States
(12) Patent Application Publication
(10) Pub. No.: US 2005/0118321 A1
(43) Pub. Date: Jun. 2, 2005

(54) Special four meat pasta sauce and method of preparation

(76) Inventor: Kenneth D. Widmeyer, Marion, IN (US)

Correspondence Address: MITCHISON LAW OFFICES, PC, 115 EAST NINTH STREET, ANDERSON, IN, 46016-1509, US

(21) Appl. No.: 11/001,373

(22) Filed: Dec. 1, 2004

Related U.S. Application Data
(60) Provisional application No. 60/526,397, filed on Dec. 2, 2003.

(51) Int. Cl. A23G 3/00

(52) U.S. Cl. 426/589

(57) ABSTRACT

A four meat, tomato-based sauce to be used with various types of pasta dishes and a specific method for making such sauce. The sauce of the invention is primarily intended as a pasta sauce, which has a unique flavor and taste. The method involved permits this unique taste to be maintained as the sauce is made in small quantities (for say a family) or is made in large batches (for say catering). The main ingredients of this invention are comprised of four different meats; various fruits and vegetables (onions; peppers; a tomato base comprised of tomato sauce, diced tomatoes, tomato paste and whole peeled tomatoes); and several spices and flavorings. The preferred embodiment of the sauce and the method of preparation are demonstrated in the accompanying drawings, tables, and flow charts.

### CROSS-REFERENCE TO RELATED APPLICATIONS:

This application claims the benefit of Provisional Patent Application Ser. No. 60/526,397 filed Dec. 2, 2003 by Kenneth D. Widmeyer and titled “SPECIAL FOUR MEAT PASTA SAUCE AND METHOD OF PREPARATION”.

### FIELD OF INVENTION

The present invention is in the field of food sauce preparation. More specifically this food sauce is a unique combination of ingredients resulting in a tasty and consistent tomato based sauce for pasta dishes and the like. Important too is the method to prepare the sauce in various quantities.

### FEDERALLY SPONSORED RESEARCH

Not Applicable.

### SEQUENCE LISTING OR PROGRAM

Not Applicable

### BACKGROUND

### A. Introduction of the Problems Addressed

Pasta sauces have traditionally been a combination of the same few ingredients. When making small quantities, the tastes could sometimes be repeated from batch to batch. However, in large quantities and in differing volumes the same repetition of a tasty and interesting combination has proven more difficult. The sauces, especially with larger quantities, have often lacked significant differences in flavor and taste. In addition, the manner to produce these prior art sauce combinations offered no special methodology to take the preparation of small quantities of sauce (for say a family meal) and use a very similar method for very large quantities of sauce (for say a large catered event).

### B. Prior Art

Historically, the prior art food recipes and combination of ingredients relating to tomato based pasta sauces were often just simple combinations that offered little variation of taste from dish to dish. Also, many of the prior art in sauces did not address the methods, but stayed more with the ingredients. Hence, to understand the full line of typical sauces that are considered prior art, a rigorous review of recipes from food and cooking publications is required.

Examples of prior patents on sauces begin with U.S. Pat. No. 5,436,022 issued to Chiang et al in 1995. This patent was entitled a Process for Producing Tomato Products of Improved Flavor. This patent teaches a complicated process of adding various alkali and food grade alcohols to the composition during different heat cycles. This is a process directed for the large tomato-based food processing industry and not a specific flavor enhancement through the natural ingredients which is the basis of the SPECIAL FOUR MEAT PASTA SAUCE AND METHOD OF PREPARATION. Another sauce patent reveals a different sauce and process. This patent was issued to Dean as a U.S. Pat. No. 5,885,644 (1999) and is entitled Garlic Sauce and Method of Preparation. It teaches a sauce without any mention of tomato or tomato-based foods. It teaches a dry mixing of garlic and other ingredients, then an addition of oils, vinegar and the like. The methodology and most ingredients are distinct from the new patent presented here.

Other examples include a U.S. Pat. No. 6,165,537 issued to Carr in 2000 entitled Method of Making a Food Product Containing Tomatoes. This patent teaches and describes as a specific way to combine various ingredients to provide a tomato-based food such as a salad dressing. It advises refrigeration and significant sweetener. Nowhere does this patent mention pasta dishes. The actual steps show a common flow chart which is utilized by many others in descriptions of a method. However the contents and description of the steps vary greatly from the methods presented here as the SPECIAL FOUR MEAT PASTA SAUCE AND METHOD OF PREPARATION. A fairly recent patent describes a Tomato-Based Caramelized Sauce and Process for Making Same. This U.S. Pat. No. 6,576,284 B1 was issued to McPeek in 2003 and teaches a long, low temperature cooking of a highly-sugared combination that creates a caramelized sauce. The method show needs careful control to achieve the results of this uniquely textured sauce. This does not utilize the same ingredients or method of the new Four Meat Sauce presented in this patent.

A background listing of a group of recipes related to this invention is noted in the following Table A. One skilled in the art of pasta sauces and their preparation appreciates well that none of these referenced the use of four distinct types of meat shown in FIG. 1. Likewise, none of the prior art recipes reference the combination, preparation and long period of simmering described in the Detailed Description, below, and shown in FIG. 5. Likewise, these referenced recipes have differing tomato bases. Finally, none of the prior recipes referenced the same combination and quantities of the spices and flavors shown in FIG. 3.

TABLE A
Showing a Partial Selection of Recipe Books
that were Searched for Similarities

| | Copyright | | |
|---|---|---|---|
| Ref. | Date | Publication Name | Recipe Name |
| E | 2001 | The All New Good | a. Spaghetti and Meatballs |
| | | Housekeeping | b. Beef and Sausage Lasagna |
| | | Cookbook | |
| F | 1998 | Italian Cooking for | Meat Sauce |
| | | Dummies | |
| G | 2001 | Lidia's Italian- | a. Gemelli with Sausage- |
| | | American Kitchen | Tomato Sauce |
| | | | b. Italian-American Meat |
| | | | Sauce |
| H | 1999 | Simply the Best | a. Tomato Sauce with Ground |
| | | Italian | Beef |
| | | | b. Meat Sauce |
| I | 2002 | The Sicilian | a. Pasta and Quick Tomato |
| | | Gentleman's Cook | Sauce |
| | | Book | b. Tomato Sauce |
| J | 1999 | The Best Recipe | a. Sausage and Pepper |
| | | | “Lasagne” |
| | | | b. Meat Sauce |
| K | 2002 | Better Homes and | a. Spaghetti with Beef and |
| | | Gardens New Cook | Mushroom Sauce |
| | | Book | b. Spaghetti Sauce |
| L | 1998 | Betty Crocker's | Italian Tomato Sauce with |
| | | Cooking Basics | Pasta |
| M | 2000 | Betty Crocker's | a. Spaghetti and Meat Balls |
| | | Cookbook | b. Italian Tomato Sauce |

The above referenced teachings do not address the scope of the present problem as stated. None of the prior art teaches all the combination and method of preparation for the SPECIAL FOUR MEAT PASTA SAUCE AND METHOD OF PREPARATION.

### SUMMARY OF THE INVENTION

The present invention relates generally to a tomato-based sauce to be used with various types of pasta dishes and provide the specific method of preparing the sauce. The new sauce invention is made from standard ingredients that are readily available from grocery stores, super markets, or other food suppliers across the United States and in other countries. The sauce and method of preparing have various advantages that will be discussed below. Likewise there are several alternate embodiments or food combinations that will be described.

The method of making and the resultant of the combination of ingredients may be utilized for small portions. The small portions may be used for example with a family meal, or the like. Additionally, the same combination of ingredients may be used for very large portions for example as a catered dinner service at a wedding reception, or the like.

This invention is a Special Four Meat Pasta Sauce and the sauce's Method of Preparation. The food composition has a unique method of preparation that will be described below. This method permits various sized portions (small, family, large catered groups, etc.) to be prepared with the same outstanding and flavorful results in the taste of the sauce. In addition, there are various alternative embodiments to provide a sauce that will satisfy differing preferences of the consumer of the product.

The main ingredients of this invention are comprised of four different meats; various fruits and vegetables (onions; peppers; a tomato base comprised of tomato sauce, diced tomatoes, tomato paste and whole peeled tomatoes); and several spices and flavorings. The preferred embodiment of the sauce and the method of preparation are shown in the accompanying drawings, tables, and flow charts.

The ingredients comprising the sauce are typical, standard, and readily available from many different sources as previously stated. While some of the main ingredients are similar to those used in other tomato-based sauces for pasta, other of the main ingredients are more unique in their use and quantity for the present food composition. The primary mixture shown in the tables as the preferred embodiment is a “four meat” composition. One skilled in the art can appreciate that many variation of the meat combinations as to type and quantity may be used to permit the full scope and spirit of this invention as described below and as depicted in the accompanying tables and flowchart.

The types of mechanisms and kitchen devices used to prepare the sauce are not unique. There is a container to hold and cook the ingredients, such a twenty quart pan with a lid, or the like; straining devices; stirring devices, such as wooden or plastic spoons and spatulas, or the like; and of course a heat source such as a gas or electric range, or the like.

It is important to note that one skilled in the art appreciates that a larger scale “commercial” preparation of this combination of ingredients would use other processes to combine the ingredients and to heat and prepare this flavorful and unique composition. Likewise, specific time, temperature and pressures might vary with the “commercial” process in order to maximize the output at larger quantities; to minimize the time; to minimize the energy for the heat source; and to minimize the labor required to produce the composition.

### Objects and Advantages

Accordingly, there are several objects and advantages of the SPECIAL FOUR MEAT PASTA SAUCE AND METHOD OF PREPARATION. One important advantage for the present invention is its enhanced flavor and robust taste. The addition of more than two meats, different types of meat than traditionally used, and the combination of spices and flavorings to a tomato base provide an unusually flavorful sauce that is robust. This robust sauce may be repeated consistently. This same sauce provides a base that may be modified somewhat to suit differing tastes.

Another advantage of this composition over others in the field is that it is fully adaptable to small, medium, and large portions. This permits one to provide the composition to various sized groups without sacrificing the flavor or the consistency of the sauce.

A further advantage is that the sauce is made from simple and inexpensive ingredients. The materials are readily available from several manufactures at super markets and grocery stores.

Still another advantage is that it is an easy method to produce. The method is fully described in simple steps that take little or no training to perform.

Finally, other advantages and additional features of the present invention will be more apparent from the accompanying tables and flow charts and from the full description of the invention. For one skilled in the art of tomato-based sauces and their preparation, such as described here, it is readily understood that the features shown in the examples with this invention are readily adapted to other types of sauces in the industry.

### DESCRIPTION OF THE DRAWINGS

There are no special accompanying drawings required to describe this invention. The Drawing Figures show Helpful Tables that are referenced in the body of the detailed description. Also, a Flow Chart, which is incorporated in and constitutes a part of this specification, illustrates the method of preparation of the sauce that is the preferred embodiment. The tables and flow charts, together with the summary description given above, and a detailed description given below serve to explain the principles of the invention. It is understood, however, that the invention is not limited to the precise arrangements and instrumentalities shown.

FIG. 1 is a Table Showing an Example of Main Ingredients.

FIG. 2 is a Table Showing an Example of Tomato Base Ingredients.

FIG. 3 is a Table Showing an Example of Spice and Flavoring Ingredients.

FIG. 4 is a Table Showing an Example of Alternative Embodiments.

FIG. 5 is a Flow Chart of the method of preparation of the sauce which is the Preferred Embodiment of Present Invention.

### DESCRIPTION OF THE REFERENCE NUMBERS

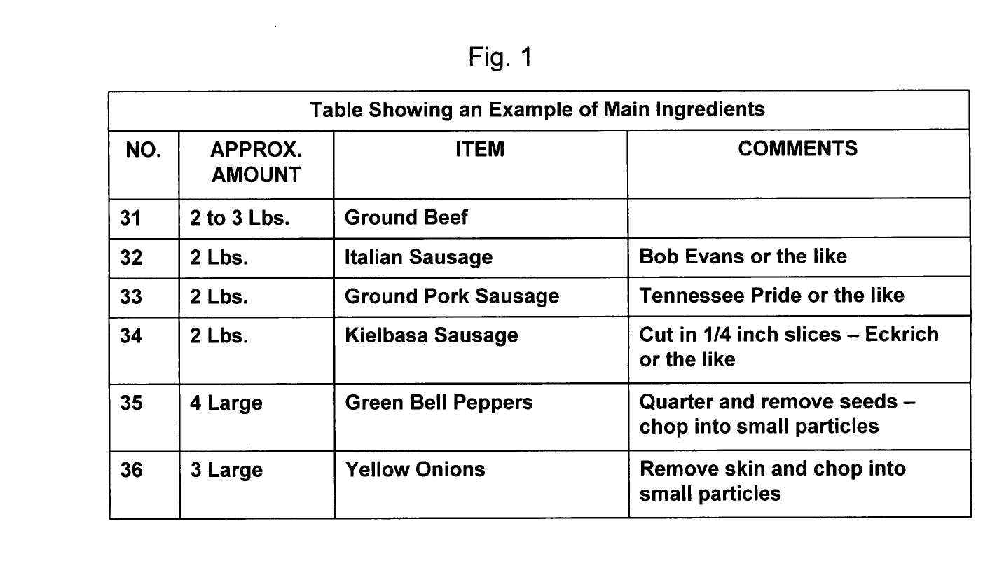

Drawings FIGS. 1 through 3 show the reference numbers for all the ingredients.

### DETAILED DESCRIPTION OF PERFERRED EMBODIMENT

The present invention is a Special Four Meat Pasta Sauce and Method of Preparation. The main components of this invention are comprised of four different meats; onions; peppers; a tomato base comprised of tomato sauce, diced tomatoes, tomato paste and whole peeled tomatoes; and several spices and flavorings.

A person having ordinary skill in the field of this invention appreciates the various ingredients, and sources of ingredients, that may be used to physically permit this special Four Meat Pasta sauce to be produced and utilized. The improvements over the existing art are providing a special sauce that:
Has enhanced flavor and robust taste;
Is fully adaptable to small medium and large portions;
Is made from simple and inexpensive ingredients; and,
Has an easy method to produce.

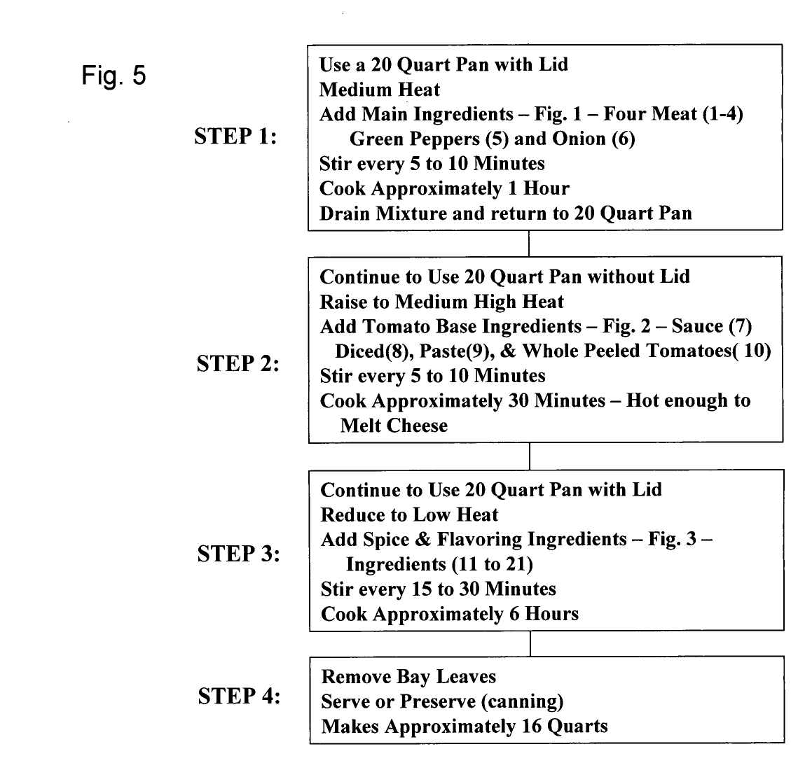

In the illustrations accompanying this description, note well that the FIG. 5 is a Flow Chart of the method of preparation of the sauce which is the Preferred Embodiment of Present Invention. The method of preparation of the sauce described is functionally understood by those skilled in the art to be appropriate for use in preparing similar sauces for pasta. One skilled in the art readily appreciates that there are various other sauces from similar combinations and configurations of the present invention. Therefore, the descriptions are exemplary and not limiting in their nature.

FIG. 1 is a Table Showing an Example of Main Ingredients. The sauce is comprised of essentially six or more main ingredients. Ground Beef 31 is one ingredient. It has no special fat content described and can range from what is commonly referred to as hamburger to a lean type that may be known as ground chuck, or similar consistencies.

Important to the flavor is an Italian sausage 32. Commonly known types are Bob Evans, Eckrich, Kahns, and the like in the Midwestern area of United States. An Italian sausage 32 of local area brands may be substituted. Ground Pork sausage 33, such as Tennessee Pride or the like is the third important meat used as a main ingredient. Finally, and critical to the flavor enhancement, is the last sausage used—Kielbasa Sausage 34. This can be Eckrich or the like.

The described meats Ground Beef 31, Italian Sausage 32, and Ground Pork Sausage 33 are already ground meats. The Kielbasa Sausage 34 is not ground and it should be cut into quarter inch thick slices or smaller to bring out and enhance the flavors of all the meat ingredients. All four meats are of about the same ratio of two pounds each for the example shown in FIG. 1. The ground beef 31 may be of somewhat more quantity, such as the three pounds described in FIG. 1.

The remaining two main ingredients are common to many tomato based meat sauces for pasta. These are Green Bell Peppers 35 and Yellow Onions 36. The peppers 35 should be quartered and seeds removed, then chopped into small particles. The onions 36 should have the skins removed and chopped into small particles.

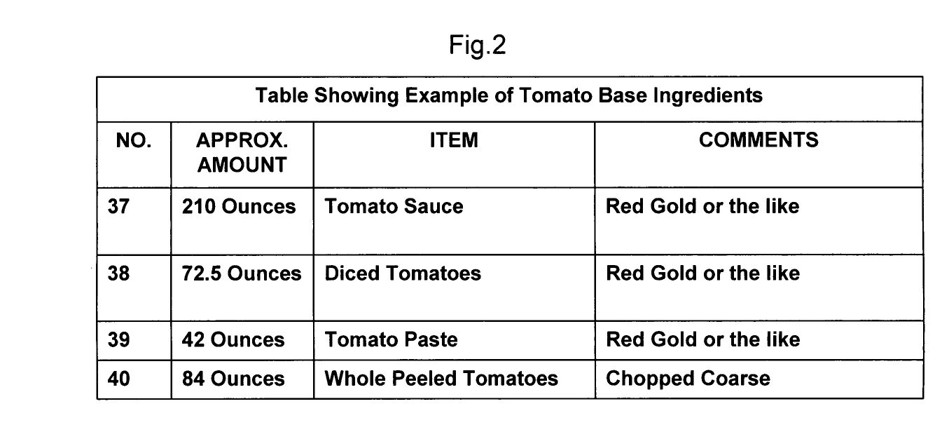

FIG. 2 is a Table Showing an Example of Tomato Base Ingredients. The Tomato Base is comprised of at least the four parts as described. Tomato Sauce 37; diced tomatoes 38; tomato paste 39; and whole peeled tomatoes 40 are those four parts. The example shown describes a ratio of about 5 parts Tomato Sauce 37 (210 oz.) to 2 parts diced tomatoes 38 (72.5 oz.) to 1 part tomato paste 39 (42 oz.) to 2 parts whole peeled tomatoes 40 (84 oz.) for the tomato products. The base unit (tomato paste 39) for the example in FIG. 2 shows approximately 42 ounces for the amount of 8 or 9 pounds of meat described as the main ingredients. One skilled in the art appreciates that several combinations of these four tomato products may provide a complimentary base for the main six ingredients in FIG. 1.

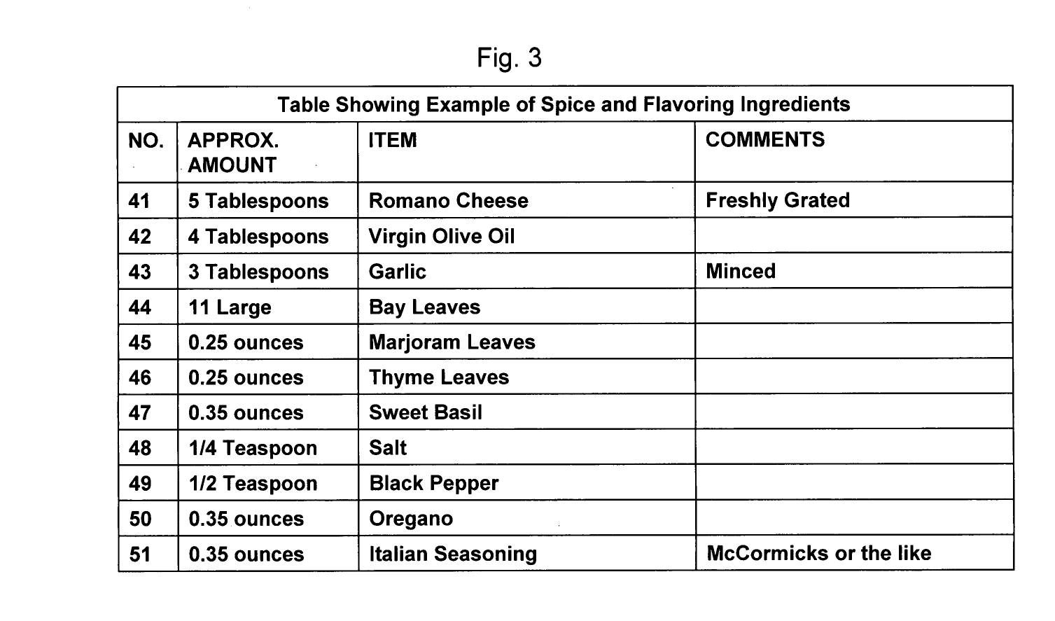

FIG. 3 is a Table Showing an Example of Spice and Flavoring Ingredients. The example shows a combination of eleven ingredients to enhance the four meat combination and tomato base described above. Freshly grated Ramano Cheese 41 is melted on top of the combination meats and tomato base. Virgin Olive Oil 42 and minced garlic 43 are added. Bay Leaves 44, Marjoran Leaves 45 and Thyme Leaves 46 are next. Finally, several flavoring spices and condiments are added. These are Sweet Basil 47, Salt 48, Black Pepper 49, Oregano 50, and Italian Seasoning 51 to complete the mixture of ingredients shown in FIG. 3. Note that the example shown in FIG. 3 provides an amount for each of the eleven (11) ingredients described. This amount corresponds to the table in FIG. 1 for an amount of 8 to 9 pounds of meat. One skilled in the art appreciates that variations of these and other spices and condiments may provide a complimentary seasoning for the main six ingredients in FIG. 1 and tomato base in FIG. 2.

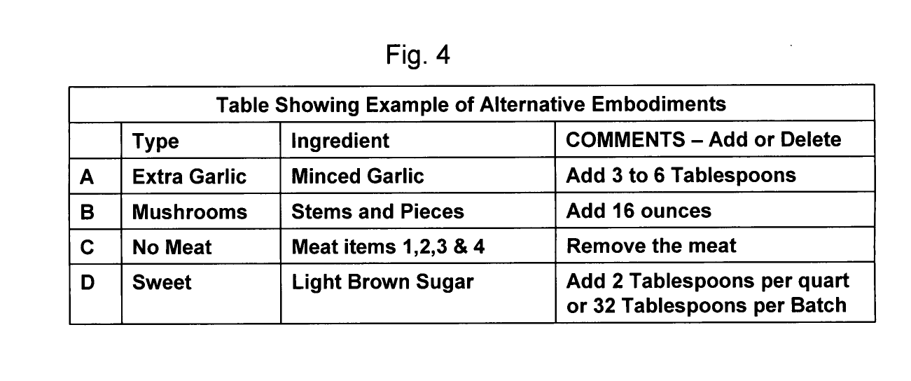

FIG. 4 is a Table Showing an Example of Alternative Embodiments. The above description of main ingredients, tomato base, and seasoning spices and condiments is the preferred embodiment of the present composition. One appreciates that variations or alternative embodiments may be derived from this preferred composition. Those alternatives are shown in FIG. 4. One alternative is “Extra Garlic” A. A second alternative embodiment is with “Mushrooms” B. Another alternative embodiment is a “No Meat” C or vegetarian type of sauce. Finally, a “Sweet Sauce” D is shown as an alternative embodiment.

In total, all the points and details mentioned here throughout this detailed description of the drawings are exemplary and not limiting. Other ingredients specific to describing a special four meat pasta sauce may be added as a person having ordinary skill in the field of this invention well appreciates. The tables in the FIGS. 1-4 have been focused on the ingredients shown in respect to the present invention.

### PREPARATION OF THE PREFERRED EMBODIMENT

FIG. 5 is a Flow Chart of the method of preparation of the sauce which is the Preferred Embodiment of Present Invention. The types of mechanisms used to prepare the sauce are not unique. There is a container to hold and cook the ingredients, such a twenty quart pan with a lid, or the like; a straining devices; stirring devices, such as wooden or plastic spoons and spatulas, or the like; and of course a heat source such as a gas or electric range, or the like.

The specific steps taken in a kitchen or food preparation area are shown in the Flow Chart in FIG. 5. These steps are divided into four basic parts:

STEP 1: One uses a 20 quart pan, with a lid. Other sizes may be substituted but need to easily contain all the ingredients combined. All the Main Ingredients from FIG. 1—the four meats 31, 32, 33 and 34; the green peppers 35; and the onions 36 are added. Then the heat is put at medium and cooked for approximately 1 hour. The mixture is to be stirred every 5 to 10 Minutes. After the 1 hour, the six main ingredients are drained with a large strainer or the like and the mixture is returned to the 20 quart pan.

STEP 2: One continues to use a 20 quart pan but now without the lid. The heat is raised to medium high. Next the tomato base ingredients shown in FIG. 2 are added. These tomato products include Sauce 37, Diced 38, Paste 39, & Whole Peeled 40. This combination is now cooked approximately 30 minutes and is stirred every 5 to 10 Minutes. The temperature at the end of this step should easily melt cheese.

STEP 3: One now continues to use 20 quart pan and again utilizes the lid. All the Spice & Flavoring Ingredients 41 to 51, shown in FIG. 3, are added. Then the heat is reduced to Low and the sauce continues to cook for approximately six (6) hours. The composition is stirred every 15 to 30 minutes.

STEP 4: At the end of STEP 3, the Special Four Meat Sauce for Pasta is removed from the heat. The Bay Leaves 44 are removed. The sauce is then served immediately served over pasta, used in other Italian dish preparation, like for lasagna, or preserved alone as a sauce (canned, freeze, or other). The example amounts described in FIGS. 1-3 make about 16 quarts of four meat sauce.

Alternative embodiments for the present invention are shown in FIG. 4, above. The method of preparation and use of these alternate types of sauces is essentially the same as shown in FIG. 5 and described above.

One skilled in the art appreciates that the manner and methods used for commercial preparation of this combination of ingredients would use other processes. Industrial mixing chambers would be utilized to combine, to stir, to heat and to prepare this flavorful and unique composition. Likewise, the specific time, temperature and pressures might vary with a commercial process. A commercial company that processes food products likely would seek to vary the time, temperatures, and pressures in order to efficiently produce this product. Such variations would be to maximize the output at larger quantities; to minimize the time; to minimize the energy for the heat source; and to minimize the labor required to produce the composition. As one skilled in the art appreciates, the ingredients shown in the detailed descriptions and illustrated in the accompanying tables and flowcharts do not limit commercial variations as to the process and manner to commercially produce. However, the base ingredients should remain essentially the same as described above.

The Special Four Meat Pasta Sauce and Method of Preparation as the present invention has been described above in connection with what is presently considered to be the most practical and preferred embodiment. Alternative embodiments that may be used have also been described in FIG. 4. These were Extra Garlic A, Mushrooms B, No Meat C and Sweet D or the like.

With these descriptions it is to be understood that the invention is not to be limited to the disclosed embodiment. On the contrary, the invention is intended to cover various modifications and equivalent arrangements included within the spirit and scope of the description that shows more than two meats and the like.

1. A four meat, tomato-based sauce comprising:
a quantity of four different types of meats;
a quantity of various fruits and vegetables;
a quantity of a tomato; and
a quantity of several spices and flavorings
whereby the ingredients are combined and processed to result in a unique and flavorful pasta sauce.

2. A four meat tomato-based sauce according to claim 1, wherein the meats comprises ground beef, Italian sausage, ground pork sausage, and Kielbasa sausage in approximately an equal quantity of parts.

3. A four meat tomato-based sauce according to claim 1, wherein the various fruits and vegetables comprises onions, peppers, and the like in approximately an equal quantity of parts.

4. A four meat tomato-based sauce according to claim 1, wherein the tomato base is comprised of tomato sauce, diced tomatoes, tomato paste and whole peeled tomatoes.

5. A four meat tomato-based sauce according to claim 4, wherein ratio in parts of the tomato sauce, diced tomatoes, tomato paste and whole peeled tomatoes are as:
5 parts tomato sauce,
2 parts diced tomatoes,
1 part tomato paste, and
2 parts whole peeled tomatoes

6. A four meat tomato-based sauce according to claim 5, wherein 1 part of this tomato base equals approximately 42 ounces and wherein an equal meat part equals approximately 2 pounds, thus the mixture having approximately eight pounds for all four types of meats.

7. A four meat tomato-based sauce according to claim 1, wherein the spices and flavorings are comprised of Romano cheese, Virgin Olive Oil, Garlic, Bay leaves, Marjoram leaves, Thyme leaves, sweet Basil, salt, black pepper, Oregano, and Italian Seasoning.

8. A four meat tomato-based sauce according to claim 1, wherein the spices and flavorings are comprised of Romano cheese, Virgin Olive Oil, Garlic, Bay leaves, Marjoram leaves, Thyme leaves, sweet Basil, salt, black pepper, Oregano, Italian Seasoning and light brown sugar.

9. A four meat tomato-based sauce according to claim 8, wherein the light brown sugar is added as 32 Tablespoons for ounces for the mixture having approximately eight pounds for all four types of meats whereby the flavor is a sweeter type sauce.

10. A four meat tomato-based sauce according to claim 1, wherein the various fruits and vegetables comprises onions, peppers, mushrooms, and the like in approximately an equal quantity of parts whereby the flavor is a mushroom type sauce.

11. A four meat, tomato-based sauce comprising the following ingredients:
a) 2 pounds ground Beef,
b) 2 pounds of Italian Sausage,
c) 2 pounds of ground Pork Sausage,
d) 2 pounds of Kielbasa Sausage,
e) 4 large green Bell peppers,
f) 3 large yellow onions,
g) 210 ounces of tomato sauce,
h) 72.5 ounces diced tomatoes,
i) 42 ounces tomato paste,
j) 84 ounces of whole peeled tomatoes,
k) 5 Tablespoons of Romano Cheese,
l) 4 Tablespoons Virgin Olive oil,
m) 3 Tablespoons of minced Garlic
n) 11 large Bay leaves,
o) ¼ ounce Marjoram leaves,
p) ¼ ounce Thyme leaves,
q) 35/100 ounces sweet Basil,
r) ¼ Teaspoon Salt,
s) ½ Teaspoon black Pepper,
t) 35/100 ounces Oregano,
u) 35/100 ounces of Italian seasoning
whereby the ingredients are combined and processed to result in a unique and flavorful pasta sauce.

12. A method for making a four meat tomato-based sauce sauce comprising:
a) STEP 1:
Use a 20 Quart Pan with Lid;
Use Medium Heat;
Add Main Ingredients-Four Meats (31 to 34);
Add Green Peppers (35) and Onion (36);
Stir every 5 to 10 Minutes;
Cook Approximately 1 Hour;
Drain Mixture; and
Return Mixture to 20 Quart Pan.
b) STEP 2:
Continue to Use 20 Quart Pan without Lid;
Raise to Medium High Heat;
Add Tomato Base Ingredients—Sauce (37) Diced (38), Paste (39), & Whole Peeled Tomatoes (40);
Stir every 5 to 10 Minutes; and
Cook Approximately 30 Minutes until Hot enough to Melt Cheese.
c) STEP 3:
Continue to Use 20 Quart Pan with Lid;
Reduce to Low Heat;
Add Spice & Flavoring Ingredients (41 to 51);
Stir every 15 to 30 Minutes; and
Cook Approximately 6 Hours.
d) STEP 4:
Remove Bay Leaves and
Serve or Preserve (canning).
